(19) United States
(12) Patent Application Publication
(10) Pub. No.: US 2012/0050258 A1
(43) Pub. Date: Mar. 1, 2012

(54) METHOD FOR OBTAINING 3D POSITION INFORMATION, COMPUTER PROGRAM, DATA PROCESSOR, AND DISPLAY PANEL INCORPORATING THE SAME

(76) Inventors: Andrew KAY, Oxford (GB); Glyn Barry PRYCE-JONES, West Midlands (GB)

(21) Appl. No.: 12/869,959

(22) Filed: Aug. 27, 2010

(51) Int. Cl. G06F 3/033; G06T 15/00

(52) U.S. Cl. 345/419

(57) ABSTRACT

A method for obtaining three-dimensional (3D) position information of one or more user-controlled objects positioned above a display panel, the display panel providing a plurality of two-dimensional (2D) directional views of the user-controlled objects from corresponding different directions. The method includes the steps of: detecting the presence of 2D objects within each of the directional views, and estimating corresponding 2D position information; estimating 3D position information for one or more 3D objects which would account for the detected 2D objects within the directional views; determining quality measures for the estimated 2D position information and/or the estimated 3D position information; and determining 3D position information of the one or more user-controlled objects as a function of the estimated 3D position information and the quality measures.

### TECHNICAL FIELD

The present invention relates to a method for obtaining and processing three-dimensional position information of a user-controlled object relative to a display panel, and to a display panel and program incorporating the same.

### BACKGROUND ART

There is an increasing interest in touch-sensitive display panels, as they provide a simplified means of interaction with the user through the measurement of two-dimensional positioning of user-controlled objects on the display panel surface.

Still further, the measurement of three-dimensional positioning of user-controlled objects above the display panel surface provides even greater user interaction, as one more degree of freedom is added. Such user-controlled objects may include, for example, pointing devices such as pens, styluses, fingertips or other objects which scatter or emit light therefrom onto the display panel.

UK Patent Application No. 0909452.5 (J. Castagner, et al.; filed Jun. 2, 2009), and PCT Application No. PCT/JP2010/059483 (J. Castagner, et al.; filed May 28, 2010), the entire disclosures of which are incorporated herein by reference, describe a display panel capable of measuring visible or invisible light impinging over a array of optical sensors distributed across the panel. The measured light includes information about the direction from which the impinging light was travelling. When a user-controlled object, such as the user's finger, hovers above the panel the object is illuminated from below by lighting provided by the panel. Some of the light is reflected by the object and returns to the panel where it is detected by the array of sensors. Each sensor effectively has its own directional aperture which allows it to preferentially sense light from a certain direction. By preferentially sensing light, each sensor inherently includes directional information relative to the other sensors in the array. Based on this directional information, the position of the user-controlled object may be ascertained in three dimensions.

Unfortunately, the directional information obtained from the array of optical sensors can be inherently unreliable. Apart from optical noise, measurement noise and electrical noise within the array of sensors, irregularities and complexities due to environmental conditions (e.g., ambient light), etc., may easily lead to spurious results. The result is that measurements from the array of sensors must be treated carefully and with suspicion.

A further complexity arises in that an object visible to the array of sensors in one directional view may be invisible in another directional view, simply from the geometry of the situation as illustrated in FIG. 1. Thus an object 400 (e.g., a user's finger) toward the left perimeter of a panel 100 may be in a field of view 21a to many of the left-looking sensors 21, but invisible with respect to a field of view 22a to all the right-looking sensors 22.

Yet another complexity arises in that multiple user-controlled objects in the field of view of the array of sensors potentially confuse the calculations of their respective three-dimensional position, as it is not trivial to calculate which object in one view corresponds to which object in another view.

In view of the aforementioned difficulties associated with obtaining reliable three-dimensional position information, there is a strong need for a method that overcomes the complexities and ambiguities in a simple and efficient manner.

### SUMMARY OF INVENTION

According to an aspect of the invention, a method is provided for obtaining three-dimensional (3D) position information of one or more user-controlled objects positioned above a display panel, the display panel providing a plurality of two-dimensional (2D) directional views of the user-controlled objects from corresponding different directions. The method includes the steps of: detecting the presence of 2D objects within each of the directional views, and estimating corresponding 2D position information; estimating 3D position information for one or more 3D objects which would account for the detected 2D objects within the directional views; determining quality measures for the estimated 2D position information and/or the estimated 3D position information; and determining 3D position information of the one or more user-controlled objects as a function of the estimated 3D position information and the quality measures.

According to another aspect, the step of determining quality measures includes determining quality measures of the 2D objects detected in the detecting step, and the step of estimating the 3D position information estimates the 3D position information as a function of the quality measures of the 2D objects.

In accordance with another aspect, the quality measures of the 2D objects are a function of an area of the corresponding 2D object.

In accordance with still another aspect, the quality measures of the 2D objects are a function of an aspect ratio of the corresponding 2D object.

According to yet another aspect, the quality measures of the 2D objects are a function of location of the corresponding 2D object relative to a border of the directional view within which the 2D object is detected.

According to another aspect, the step of determining quality measures includes determining quality measures of the 3D objects of which the 3D positions are estimated, and the step of determining 3D position information of the one or more user-controlled objects determines the 3D position information as a function of the quality measures of the 3D objects.

In still another aspect, the quality measure of a 3D object which would account for the detected 2D objects within the directional views is a function of consistency of position of the detected 2D objects in relation to at least one of the 2D dimensions.

According to another aspect, the quality measure of a 3D object which would account for the detected 2D objects within the directional views is a function of similarity of at least one of size and shape of the detected 2D objects.

In accordance with another aspect, the step of determining 3D position information of the one or more user-controlled objects determines the 3D position information by weighting the estimated 3D position information of the 3D objects by the corresponding quality measures.

According to another aspect, the step of determining 3D position information of the one or more user-controlled objects the estimated 3D position information for a plurality of 3D objects is subjected to a clustering algorithm.

According to another aspect, the step of estimating 3D position information for one or more 3D objects which would account for the detected 2D objects within the directional views includes pairing each 2D object detected in a given one of the directional views with each 2D object detected in the other directional views and estimating, for each pairing, 3D position information for a 3D object which would account for the paired 2D objects.

In accordance with yet another aspect, the step of determining 3D position information of the one or more user-controlled objects includes subjecting the estimated 3D position information obtained from the pairings to a clustering algorithm.

According to another aspect, the step of detecting the presence of 2D objects within each of the directional views, and estimating corresponding 2D position information includes at least one filtering step.

In accordance with still another aspect, the step of estimating 3D position information for one or more 3D objects which would account for the detected 2D objects within the directional views includes at least one filtering step.

According to another aspect, a computer program stored on a non-transitory machine readable medium is provided, the computer program when executed by a data processor causing the data processor to carry out the method described herein.

According to still another aspect, a data processor is provided configured to carry out the method described herein.

In accordance with another aspect of the invention, a display panel is provided. The display panel includes a sensor array layer which provides a plurality of two-dimensional (2D) directional views from different directions of one or more user-controlled objects above the display panel; and a data processor configured to carry out the steps of: detecting the presence of 2D objects within each of the directional views, and estimating corresponding 2D position information; estimating 3D position information for one or more 3D objects which would account for the detected 2D objects within the directional views; determining quality measures for the estimated 2D position information and/or the estimated 3D position information; and determining 3D position information of the one or more user-controlled objects as a function of the estimated 3D position information and the quality measures.

According to the present invention, several images of reflected or emitted light from objects within a sensed region above a display panel are available from one or more sensors. Each image represents a different preferred direction of received light. These images received from different preferred directions are respectively referred to herein as “directional views”. A data processor analyses the directional views and attempts to calculate 3D representations of any objects within the sensed region. Each representation includes an estimated height or distance, z, from the panel, and a position (x, y) indicating a point on the panel above which the object can be considered to lie. Each representation may also include a measure of certainty (or reliability) of each set of parameters.

The data processor is configured such that each subset in a determined collection of subsets of the available directional views is used to calculate a (possibly empty) set of position estimates, together with a measure of confidence of each position estimate. Each position estimate and confidence measure may be construed as evidence for the existence of an object. Further, the data processor is configured to combine the evidence from the subsets of directional views to output more confident position estimates, together with confidence estimates.

One advantage of the method disclosed herein is that the complexities and ambiguities of sensing and estimating the three-dimensional position of an object above a display panel may be overcome in such a way which results in a simple algorithm, which is therefore inexpensive to design, verify and test; and requires low computational requirements, which are therefore inexpensive to implement.

Another advantage of the present invention is that position estimates obtained from the method are provided with confidence estimates. These position and confidence estimates may, for example, be used by another component in a gesture-based user interface system to create a more robust and flexible application.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, like references indicate like parts or features:

FIG. 1 shows an object visible to a left sensor, but to no right sensor.

FIG. 2 shows a display panel in accordance with an exemplary embodiment of the present invention.

FIG. 3 represents an exemplary pattern of sensitivity directions within the array of sensors.

FIG. 4 shows an example set of four images of a single object using four sets of sensors each set with its own preferred direction.

FIG. 5 shows the whole processing method in outline.

FIG. 6 shows the processing method of unit 41.

FIG. 7 shows the processing method of unit 42.

FIG. 8 shows one case for calculating a 3D position from two views.

FIG. 9 shows another case for calculating a 3D position from two views.

### DETAILED DESCRIPTION OF INVENTION

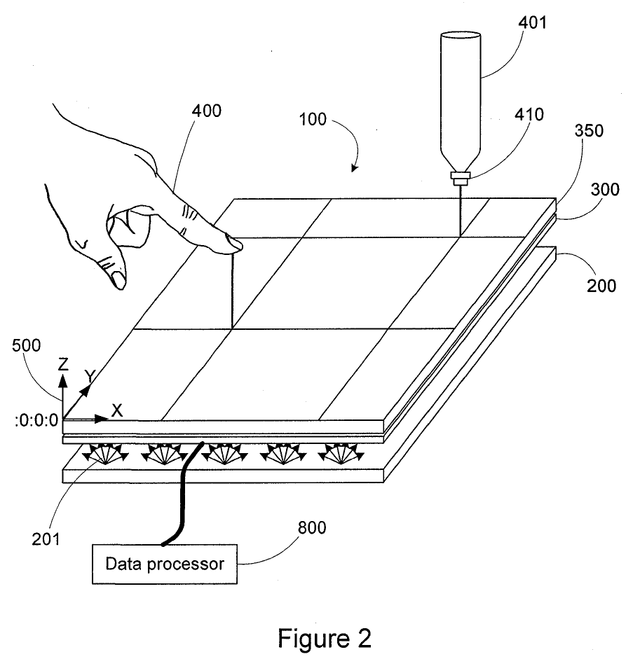

FIG. 2 illustrates a display panel 100 in accordance with an exemplary embodiment of the invention. The display panel 100 includes an array of optical sensors embedded within a thin film transistor (TFT) layer 300. In accordance with the invention, the three-dimensional position of one or many user-controlled objects such as a finger 400 or stylus 401 may be determined. For example, light scattered by the finger 400 is incident upon the sensor array layer 300 as a result of being illuminated by a backlight element 200. Specifically the backlight element 200 emits light toward the finger 400 through the semi-transparent sensor array layer 300 and transparent surface layer 350 of the display panel 100. Alternatively, a light emitting user-controlled object such as a light stylus 401 may include a tip 410 which emits light that interacts directly with the array of optical sensors embedded within the layer 300.

Although not shown, the display panel 100 includes a liquid crystal layer, electrowetting layer, etc., for presenting a display to a user. Such display may include icons, menu selections, etc. which the user may select or control by virtue of the three-dimensional position information of the user-controlled object as obtained by the display panel 100.

Multiple user-controlled objects may simultaneously interact optically with the optical sensors in layer 300 and be spatially localized above the surface of the display panel 100 relative to a three-dimensional reference (or Cartesian coordinate) system 500 as distinct pattern entities from a pixelated image, each pixel of which represents a scaled signal generated by one or many light sensors embedded in the sensor array layer 300.

The sensor array layer 300 includes one or more layers (not shown) that modify the passage of scattered or emitted light from scattering or emitting user-controlled objects (e.g., 400 or 401) through to one or many of the optical sensors in a suitable manner with a desired effect. These layers may include an array of apertures formed by one or more masks, microlenses, louvers, etc., or combination thereof, which tend to prevent light which is incident normally on the surface of the display panel 100 from reaching the sensors which light which is incident obliquely from one or more predefined directions are permitted to reach the sensors. For example, the layer 300 may include a first sub-array of sensors from which light may be received primarily only from a leftward direction, a second sub-array of sensors from which light may be received primarily only from a rightward direction, a third sub-array of sensors from which light may be received primarily only from an upward direction, and a fourth sub-array of sensors from which light may be received primarily only from a downward direction. The output of each sub-array of sensors in turn represents a corresponding field of view of the display panel 100.

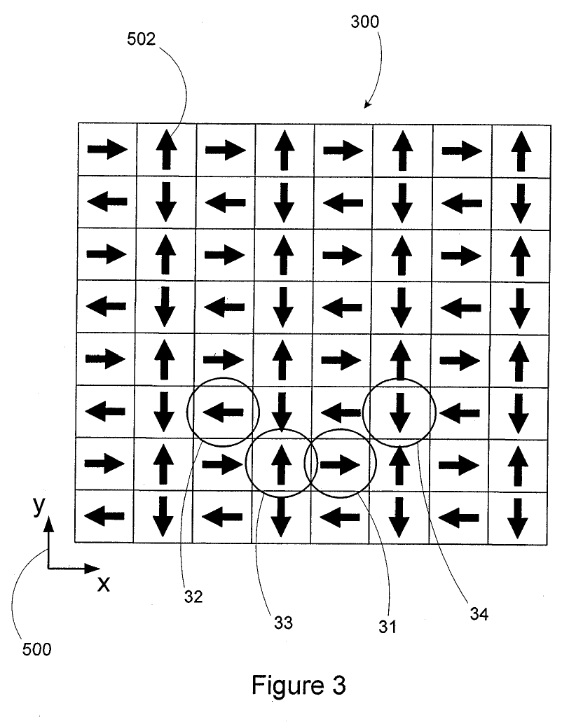

FIG. 3 presents an example where the one or more layers are arranged to modify the passage of scattered or emitted light so as to define regularly alternating directions of view across the array. Rays 502 indicate the direction of the field of view on top of each sensor embedded within sensor array layer 300 with respect to x or y direction of reference 500. In FIG. 3, the sensors are arranged as four sub-arrays with azimuthal components of the directions in which the sensors within the sub-arrays receive light such that the azimuthal components of the second to fourth sub-arrays are at 90°, 180° and 270°, respectively to that of the first sub-array at 0°. Consequently, each sensor provides an output which includes x,y positional information based on its x,y location within the array layer 300.

The particular manner in which the sensor array layer 300 within the display 100 is constructed to provide sensors having different fields of view is not germane to the present invention and moreover will be apparent to those having ordinary skill in the art based on the description herein. Consequently, additional detail has been omitted for sake of brevity. Exemplary constructions may be found in the above-mentioned UK Patent Application No. 0909452.5 and PCT Application No. PCT/JP2010/059483, the disclosures of which are incorporated herein by reference.

Referring again to FIG. 2, multiple images of light reflected from an object (such as finger 400) or light transmitted from an object (such as light-emitting object 401) located above the panel are therefore available from the sensor array layer 300. Each image represents a different preferred direction of returning light based on the particular sub-array. Each image represents what is referred to herein as a “directional view”. A data processor 800 analyses these views and calculates three-dimensional (3D) representations of any objects within the sensed region. Each representation includes an estimated height or distance, z, from the panel 100, and a position (x, y) indicating a point on the panel 100 above which the object 400,401 can be considered to lie. Each 3D representation may also include a measure of certainty (or reliability) of each set of parameters.

The data processor 800 is programmed to execute the methods described herein in accordance with the invention. The data processor 800 may include a microprocessor, microcontroller, ASIC, or the like. The data processor 800 may be part of the display panel 100 itself. Alternatively, the data processor 800 may be a separate device such as a general purpose computer or the like which is connectable to the display panel 100 to receive and process the information output by the sensors within the array 300. A computer program which, when executed by the data processor 800, causes the data processor 800 to carry out the methods described herein may be stored in a machine readable storage medium such as magnetic or optical disk drive, flash memory or other non-volatile memory, etc. The present invention includes such a program. The precise computer code or language for carrying out the functions described herein is not intended to be limited in any way. Those having ordinary skill in the field of computer programming will readily understand how to develop sufficient computer code to enable the data processor 800 or other computer to carry out the aspects of the invention based on the steps described herein.

As will be described in more detail below, the data processor 800 interprets the several directional views which are obtained from the optical sensor array 300. The data processor 800 uses subsets of the available directional views to calculate a (possibly empty) set of position estimates, together with a measure of confidence of each position estimate. Each position estimate and confidence measure may be construed as evidence for the existence of an object. The data processor 800 further combines the evidence from the subsets to output more confident position estimates, together with confidence estimates.

An exemplary method carried out by the data processor 800 will now be described. However, it will be appreciated by those having ordinary skill in the art that the precise method of the calculation is given here is merely exemplary, and there are a wide range of calculations in a similar spirit which could be substituted with similar resulting performance of the entire method.

As referred to herein, a two-dimensional (2D) object means an image feature appearing in one of the dimensional views provided by the sensor array layer 300, or a data structure to describe such a feature. It may be represented by a position coordinate pair (x, y) in the coordinate system 500, and perhaps other information, such as general shape, size, which view it appears in and estimated quality. A 2D object may or may not indicate a projection of a real object (e.g., 400,401) in 3D space onto a sensor view. For example, sensor noise may be responsible for a false indication of an object. However, it is a candidate for such a projection. Similarly, a 3D object as referred to herein is a data structure which is a candidate, inferred from two or more 2D objects, which may or may not represent a real object in space. A 3D object may be represented as a triple coordinate (x, y, z) for its position in the coordinate system 500, as well as, possibly, other data such as which 2D objects the 3D object arose from, a bounding box and estimated quality.

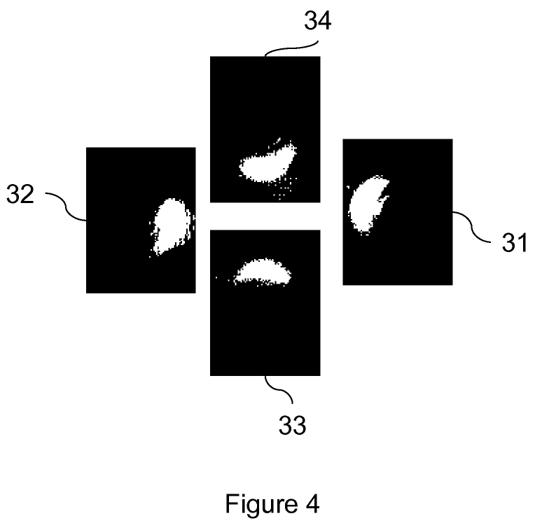

In this exemplary embodiment we suppose that the sensors within the sensor array layer 300 provide four different directional views of the incoming light, as exemplified in FIG. 4. Here the directional views arise from sensors with preferred direction to the left (L) 32, right (R) 31, up (U) 33 and down (D) 34. Here “up” and “down” correspond to the positive and negative y direction, in the plane of the sensor panel. Each directional view consists of sensors representing pixels which roughly cover the extent of the sensor array layer 300 of the panel 100. For example, FIG. 3 illustrates the orientation of the azimuthal arrangement of the sub-array of pixels making up each of the left (L) 32, right (R) 31, up (U) 33 and down (D) 34 directional views.

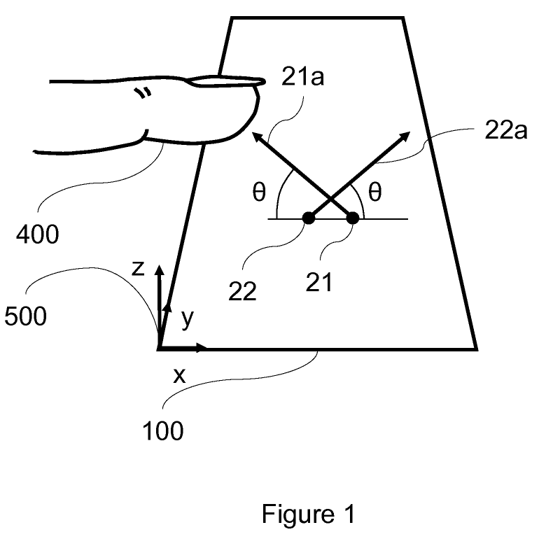

The pixels may be regarded as taking values between 0 (no received light) and 1 (maximum received light). Thus, given a user-controlled object (e.g., 400,401) above the panel 100, it will appear offset to the right in the left-looking sensor view 32; and offset to the left in the right-looking sensor view 31 as exemplified in FIG. 4. The amount of this offset is determined by the height of the object in the z direction, and the elevation angle θ of the directional field of view of the corresponding sensors as shown in FIG. 1. For simplicity it is assumed that all sensors in the sensor array panel 300 have the same elevation angle, θ, though one skilled in the art will surely be able to adapt what follows to the case where different sensors have different elevation angles θ. Similarly, the principles of this method apply to any number of directional views available from the sensors, so long as there are at least three.

The angle of elevation θ simply describes the angle above the plane of the panel 100 at which the given sensor is most sensitive to incoming light. Thus a “left looking” sensor actually is most sensitive to a direction to its left, but elevated above the plane by a certain angle, θ.

It will be convenient in the explanation to define the quality of an object or match to be a scalar in the range 0 (terrible) to 1 (excellent), though a different range, or even a non-scalar measure could be used without changing the nature of the method, as will be obvious.

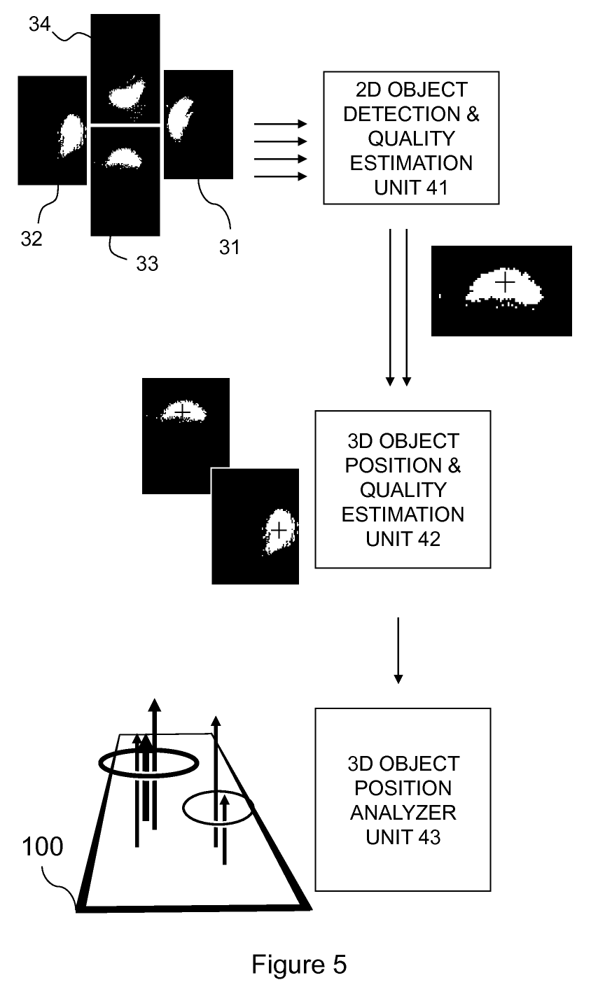

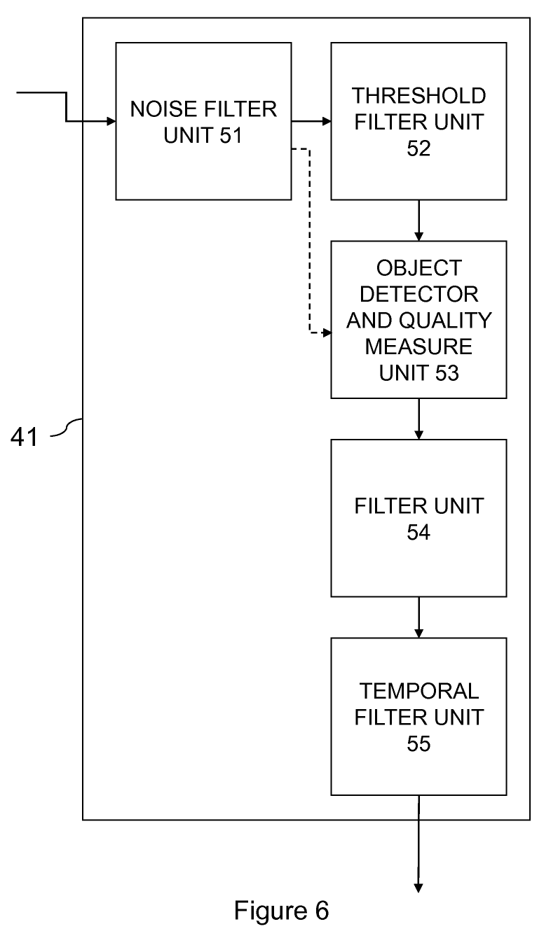

FIG. 5 shows in outline the processing steps carried out by the data processor 800 to convert the four directional views 31-34 into 3D position coordinates. In a given time interval, the data processor 800 acquires the four directional views 31-34 from the sensor array layer 300. The directional views 31-34 are two-dimensional and are initially processed in a 2D object detection and quality estimation unit 41 embodied within the data processor 800. As described in more detail below in relation to FIG. 6, the 2D object detection and quality estimation unit 41 examines each directional view separately, and determines the presence of any objects (e.g., a finger 400 or stylus 401). With respect to any objects identified in the respective directional views, referred to herein as 2D objects, the data processor 800 records their estimated 2D coordinates (x,y) and preferably information about the quality of the estimation.

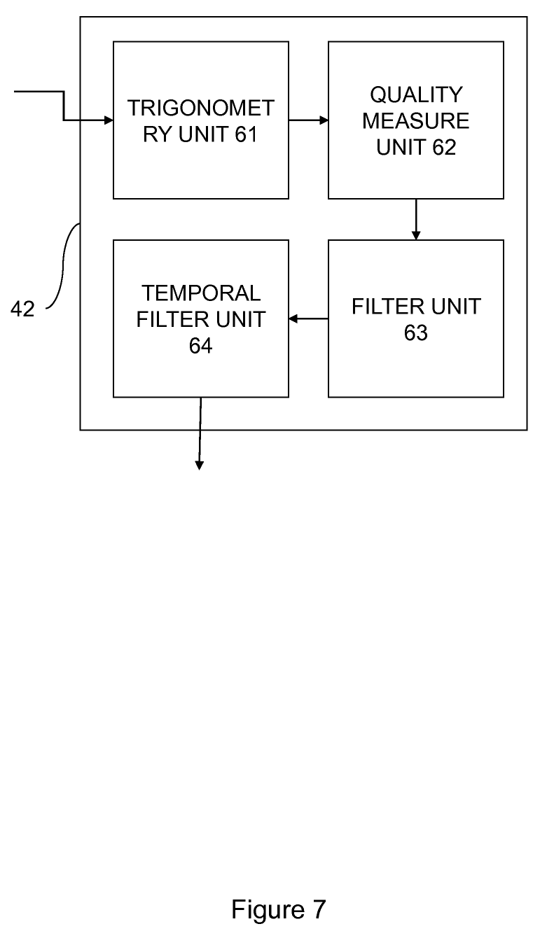

The data processor 800 further includes a 3D object position and quality estimation unit 42 which processes the 2D position and quality information from unit 41. As discussed in more detail below in relation to FIG. 7, the 3D object position and quality estimation unit 42 operates on each possible pair of 2D objects identified in the different directional views 31-34 in unit 41. The data processor 800 in unit 42 estimates from each of the possible pairs of 2D objects the position of a 3D object (x,y,z) which would account for the 2D objects, if possible. Preferably, the data processor 800 also records information about the quality of the 3D position estimation.

The data processor 800 further includes a 3D object position analyzer unit 43. The 3D object position analyzer unit 43 processes the 3D object position and quality information obtained from unit 42 as a result of all the possible pairs of 2D objects. The 3D object position analyzer unit 43 filters the 3D object position and quality information in order to choose the most likely 3D object or objects to account for that information. The output of unit 43 is taken to be the output of the process as a whole, and represents the 3D position information of the one or more user-controlled objects above the panel 100.

FIG. 6 shows in more detail one possible, preferred, implementation of the 2D object detection and quality estimation unit 41 of FIG. 5. Data from the sensors in the sensor array layer 300 is preferably filtered to remove noise in a digital noise filter unit 51 carried out within the data processor 800. Such filtering may be used to remove fixed pattern noise as well as other kinds of noise in the directional views 31-34, and may include a calibration step to determine the noise parameters. The data processor 800 may also use temporal or adaptive filtering, depending on the characteristics of the sensor array layer 300. The data processor 800 may also utilize median filtering, low pass spatial filtering and other noise filtering. The noise-filtered data from unit 51 is passed to a threshold filter unit 52 which maps each pixel in the directional views 31-34 to binary level 0 (background) or 1 (object) according to whether the original pixel is respectively below or above a threshold. The threshold may be determined dynamically or statically, and may depend on a separate calibration step. The aim of this step is to separate objects such as a finger 400 or stylus 401 from background in each directional view for the next step. Regions marked as objects are detected with an object detector unit 53 embodied in the data processor 800. Depending on the design of the object detector unit 53, it may not be necessary to use the threshold filter unit 52 as represented in dashed line. The object detector unit 53 uses geometrical information from the pixels to identify regions corresponding to objects in each directional view. For example, the object detector unit 53 may be configured to find contiguous regions of pixels marked 1, using a standard connected components algorithm. Standard morphological operations can be used to close small but insignificant “holes” which would otherwise make objects fragment. Each object candidate is measured to estimate the likelihood that it is correctly recognised, and to act as a quality measure. For example, the extent of the bounding box, the variance of the pixel coordinates, the sum of the original pixel values (before thresholding) that make up the object. The position of the object center is preferably estimated as the mean position of the pixels that define it. Alternatively the weighted mean pixel position (i.e. the centroid) using as weights the pre-threshold values of the pixels before thresholding may be used. Alternatively, the center of the bounding box may be used. Alternatively, some other method may be used to determine the centre of the object. Next, in filter unit 54 only the most significant or likely objects (using the quality measurements from 53) are retained, any others are assumed to be due to noise and ignored. Optionally a temporal filter 55, such as a standard Kalman filter, may be used to track objects and smooth out any measurement error in position so as to arrive at the most significant or likely objects.

For judging the quality Q of a 2D object in the 2D object detection in unit 41, the data processor 800 may be configured to use various heuristics. For example, a larger 2D object naturally corresponds to a higher quality, as it is more likely to represent a true 3D object, therefore the data processor 800 could take Q simply to be a decreasing function of object area, with 1 for the largest possible area and 0 for, say, a single pixel object. In at least one embodiment of the sensors, left and right 2D objects tend to be stretched in the y direction, whereas up and down 2D objects tend to be stretched in the x direction. The data processor 800 could be configured to modify each Q dependent on the aspect ratio of the 2D object measured. Thus Q should be increased when the aspect ratio of the 2D object is larger in the expected direction (according to which sensor it came from), and decreased if the aspect ratio is larger in the non-expected direction. Objects, especially small ones, adjacent to any border of the sensor array layer 300, are suspect, and should be downgraded by reducing Q.

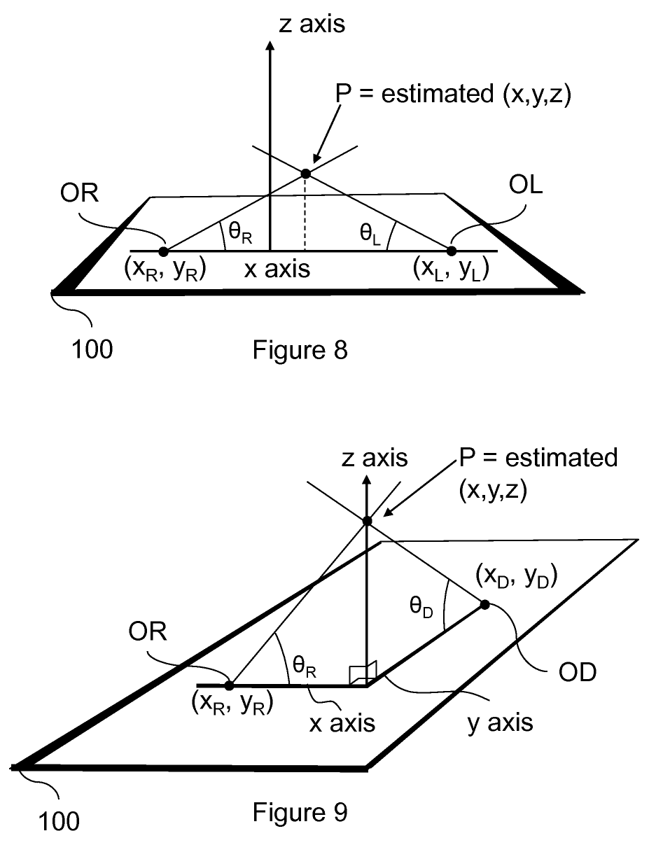

The preferred implementation of the 3D object position and quality estimation unit 42 of FIG. 5 is shown in FIG. 7. The data processor 800 takes the 2D object positions and associated quality measures from unit 41. Then, the data processor 800 pairs each 2D object of a given directional view with every other possible 2D object found in a different directional view, and analyzes the pair as follows. Firstly, the data processor utilizes a trigonometry unit 61 which uses trigonometry principles to determine if there is a 3D object consistent with both 2D objects, and if there is, what its position is likely to be (see, for example, FIGS. 8 and 9 discussed below). Secondly, the data processor 800 includes a quality measure unit 62 which compares the quality of each of the two 2D objects in the given pair, and the degree of 3D consistency is used to estimate a quality measure of the 3D object arrived at in the unit 61. The data processor 800 may utilize an optional filter unit 63 to discard 3D objects identified in the trigonometry unit 61 which have low quality, and another temporal filter 64 may be used for temporal smoothing of the 3D object positions, using for example a standard Kalman filter.

Exemplary trigonometric principles utilized in the trigonometry unit 61 for combining two 2D object views to construct a 3D object are now described with reference to FIGS. 8 and 9 In the exemplary scenario where there are 4 different directional views, (L) 32, (R) 31, (U) 33 and (D) 34 (also referred to herein simply as L, R, U and D, respectively), there are two cases: the different directional views may be parallel, such as L and R; or perpendicular, such as R and D.

FIG. 8 illustrates the calculation for the case where the two directional views containing the pair of 2D objects are parallel, exemplified by the views L and R. Suppose that a 2D object OR has been identified at position (x_{R}, y_{R}) in the R view, and a 2D object O_{L} has been identified at position (x_{L}, y_{L}) in the L view. If the two y coordinates are close, and x_{R} is to the left of x_{L}, then it is possible that OL and OR correspond to the same 3D object, P, at (x,y,z), where x, y and z are to be determined, along with the quality Q of this 3D object P. The quality of just the match, QM is at a maximum when y_{L}=y_{R}, and decreases as a function of the absolute difference between them. For example, the data processor may be configured to take QM=1/(abs(y_{L}−y_{R})+1). The data processor 800 could also incorporate terms which would give a higher quality if the objects OL and OR are of similar shape and size. For a measure of the quality Q of this 3D object the data processor 800 can, for example, multiply the quality QL of OL, the quality QR of OR and QM. Thus Q=QL*QR*QM. Using simple trigonometry and simple assumptions about measurement noise the data processor 800 is configured to take y=(y_{L}+y_{R})/2, x=(x_{L} tan(θ_{L})+x_{R} tan(θ_{R}))/(tan(θ_{L})+tan(θ_{R})), and z=(x−x_{R})tan(θ_{R}). If the elevation angles θ_{L} and θ_{R} happen to be equal, with value θ, then x=(x_{L}+x_{R})/2, and z=(x_{L}−x_{R})tan(θ)/2.

FIG. 9 illustrates in a similar way the preferred calculation for the case of two perpendicular directional views including the given pair of 2D objects, here the directional views exemplified by R and D. Suppose that a 2D object OR has been identified at position (x_{R}, y_{R}) in the R view, with quality QR, and a 2D object O_{D} has been identified at position (x_{D}, y_{D}) in the D view, with quality QD. The data processor 800 is configured to take x=x_{D} and y=y_{R}. There are two possible ways for calculating z, either as z_{R}=((x−x_{R})*tan θ_{R}) starting at OR and moving right and z-wards at angle θ_{R}, or as z_{D}=((y_{D}−y)*tan θ_{D}) by starting at OD and moving down (negative y-wards) and z-wards at angle θ_{D}. The data processor 800 is configured to calculate the final z to be some combination of z_{R} and z_{D}, preferably the mean, (z_{R}+z_{D})/2.

As one example as to how to calculate the quality of the 3D object, Q, in unit 62, let Q1 be a quality measure of how close x_{D} is to x_{R}+(z*tan θ_{R}), so that 1 is a perfect match, and Q1 tails away towards 0 when the match is poor. Similarly let Q2 be a quality measure of how close y_{R} is to y_{D}−(z*tan θ_{D}). The data processor 800 then preferably calculates Q=Q1*Q2*QR*QD.

Next is described the preferred method of operation of the unit 43 that analyses the list of potential 3D objects (xᵢ,yᵢ,zᵢ) as identified in unit 42 with their corresponding quality measures Qᵢ, and returns the most likely 3D objects as representing the actual 3D object, e.g., the user-controlled object such as finger 400 and/or stylus 401). There are two cases depending on whether a single 3D object is expected as output (e.g., a finger 400), or multiple objects (e.g., a finger 400 and a stylus 401 simultaneously; or several fingers simultaneously). The latter would apply to a device allowing a 3D analogue of “multitouch”.

For a single object application case it may suffice to perform steps as follows. First, the data processor 800 finds the mean (x,y,z) position, weighted by the quality measure: x=ΣxᵢQᵢ/ΣQᵢ (and similarly for y and z). The data processor 800 then discards 3D objects which are far from the mean, and repeats the calculation omitting the discarded 3D objects. The new weighted mean may optionally be filtered by a temporal filter (such as a standard Kalman filter) before being output as the final result.

For a multi-object application, the data processor 800 may be configured to cluster the 3D objects using a standard clustering algorithm such as k-mean clustering. Then each cluster is a potential output, depending on its quality. For example, the quality of a cluster may be calculated as a function of the quality of its component 3D objects, and their spatial variance, with tighter clusters more likely to indicate true 3D objects. Finally the best quality clusters may be temporally filtered (as before) and then output. This method may also be used for the single-object application case, but of course only a maximum of one cluster (the best, if any) would be output.

In an alternative embodiment, the data processor 800 may also judge the clusters on presence or absence of information. For example, if the 3D position is located above the center of the panel 100 it would be expected to have 3D object candidates from every pair of directional views. However, if the 3D position is located in a corner of the panel 100, it would be expected to have 3D object candidates from only the two directional views that can “see” in that corner. In either case, each potential 3D cluster could be checked that the data is consistent in this way. Further, or alternatively, for each potential 3D object the data processor 800 could check that the expected 2D objects are all present in their appropriate views.

In an alternative embodiment the 2D objects are combined differently in unit 61 as follows: a 2D object position, call it A, is chosen from the 2D objects found in a certain directional view. As before, another object B is found from another view, and combined with A to form a potential 3D object. The 3D object is checked against the available 2D points in each the remaining views (that is, views containing neither A nor B) as follows: if the 3D object would not be visible from that view (because it is off the edge as in FIG. 1) then the check passes for that view. On the other hand, if the object would be visible from that view, then the 2D position it would appear at can easily be calculated by trigonometry. The check passes if and only if there is in fact a 2D object at the predicted position. Alternatively, a quality measure can be awarded, depending on how far away in 2D the nearest 2D object is from the predicted position.

Upon determination of the 3D position of the user-controlled objects as described in FIGS. 5-9, the data processor 800 may continue with other functional operations associated with the display panel 100. Such other operations may include opening or closing menus in a graphical user interface, moving icons on the display panel 100, etc. The purpose and operation of such functions is not germane to the present invention, and therefore further detail is omitted.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

The present invention provides a method for obtaining reliable three-dimensional position information in relation to a display panel in a manner which is simple and efficient so as to minimize cost and improve efficiency.

1. A method for obtaining three-dimensional (3D) position information of one or more user-controlled objects positioned above a display panel, the display panel providing a plurality of two-dimensional (2D) directional views of the user-controlled objects from corresponding different directions, the method comprising the steps of:
detecting the presence of 2D objects within each of the directional views, and estimating corresponding 2D position information;
estimating 3D position information for one or more 3D objects which would account for the detected 2D objects within the directional views;
determining quality measures for the estimated 2D position information and/or the estimated 3D position information; and
determining 3D position information of the one or more user-controlled objects as a function of the estimated 3D position information and the quality measures.

2. The method according to claim 1, wherein the step of determining quality measures comprises determining quality measures of the 2D objects detected in the detecting step, and the step of estimating the 3D position information estimates the 3D position information as a function of the quality measures of the 2D objects.

3. The method according to claim 2, wherein the quality measures of the 2D objects are a function of an area of the corresponding 2D object.

4. The method according to claim 2, wherein the quality measures of the 2D objects are a function of an aspect ratio of the corresponding 2D object.

5. The method according to claim 2, wherein the quality measures of the 2D objects are a function of location of the corresponding 2D object relative to a border of the directional view within which the 2D object is detected.

6. The method according to claim 1, wherein the step of determining quality measures comprises determining quality measures of the 3D objects of which the 3D positions are estimated, and the step of determining 3D position information of the one or more user-controlled objects determines the 3D position information as a function of the quality measures of the 3D objects.

7. The method according to claim 6, wherein the quality measure of a 3D object which would account for the detected 2D objects within the directional views is a function of consistency of position of the detected 2D objects in relation to at least one of the 2D dimensions.

8. The method according to claim 6, wherein the quality measure of a 3D object which would account for the detected 2D objects within the directional views is a function of similarity of at least one of size and shape of the detected 2D objects.

9. The method according to claim 6, wherein the step of determining 3D position information of the one or more user-controlled objects determines the 3D position information by weighting the estimated 3D position information of the 3D objects by the corresponding quality measures.

10. The method according to claim 1, wherein in the step of determining 3D position information of the one or more user-controlled objects the estimated 3D position information for a plurality of 3D objects is subjected to a clustering algorithm.

11. The method according to claim 1, wherein the step of estimating 3D position information for one or more 3D objects which would account for the detected 2D objects within the directional views comprises pairing each 2D object detected in a given one of the directional views with each 2D object detected in the other directional views and estimating, for each pairing, 3D position information for a 3D object which would account for the paired 2D objects.

12. The method according to claim 1, wherein the step of determining 3D position information of the one or more user-controlled objects comprises subjecting the estimated 3D position information obtained from the pairings to a clustering algorithm.

13. The method according to claim 1, wherein the step of detecting the presence of 2D objects within each of the directional views, and estimating corresponding 2D position information comprises at least one filtering step.

14. The method according to claim 1, wherein the step of estimating 3D position information for one or more 3D objects which would account for the detected 2D objects within the directional views comprises at least one filtering step.

15. A computer program stored on a non-transitory machine readable medium, the computer program when executed by a data processor causing the data processor to carry out the method recited in claim 1.

16. A data processor configured to carry out the method recited in claim 1.

17. A display panel, comprising:
a sensor array layer which provides a plurality of two-dimensional (2D) directional views from different directions of one or more user-controlled objects above the display panel; and
a data processor configured to carry out the steps of:
detecting the presence of 2D objects within each of the directional views, and estimating corresponding 2D position information;
estimating 3D position information for one or more 3D objects which would account for the detected 2D objects within the directional views;
determining quality measures for the estimated 2D position information and/or the estimated 3D position information; and
determining 3D position information of the one or more user-controlled objects as a function of the estimated 3D position information and the quality measures.
